(19) United States
(12) Patent Application Publication
(10) Pub. No.: US 2005/0064259 A1
(43) Pub. Date: Mar. 24, 2005

(54) Hydrogen diffusion electrode for protonic ceramic fuel cell

(75) Inventor: W. Grover Coors, Golden, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Protonetics International, Inc., Golden, CO (US)

(21) Appl. No.: 10/923,500

(22) Filed: Aug. 20, 2004

Related U.S. Application Data
(60) Provisional application No. 60/505,894, filed on Sep. 24, 2003.

(51) Int. Cl. H01M 8/10; H01M 4/90; H01M 4/92; H01M 8/12; H01M 8/18; H01M 8/06; H01M 4/94

(52) U.S. Cl. 429/30; 429/33; 429/40; 429/21; 429/19; 429/17

(57) ABSTRACT

A proton conducting fuel cell that includes an electrolyte having a proton conducting ceramic electrolyte and a two-phase diffusion membrane electrode contacting the electrolyte, where the electrode is substantially non-porous and permeable to hydrogen. Also, a method of generating molecular hydrogen from a proton conducting fuel cell having a positive and negative electrode in contact with a proton conducting ceramic electrolyte, including selectively extracting pure hydrogen from a hydrogen gas mixture, and electrolyzing water vapor at a positive electrode of the fuel cell to form molecular oxygen (O₂) and hydrogen ions, and reducing the hydrogen ions at a negative electrode of the fuel cell to form molecular hydrogen (H₂).

### CROSS-REFERENCES TO RELATED APPLICATIONS

This application claims the benefit of U.S. Provisional Application No. 60/505,894, filed Sep. 24, 2003, and entitled “Protonic Ceramic Fuel Cell Technology” the entire contents of which are herein incorporated by this reference.

### FIELD OF THE INVENTION

The present invention includes ceramic proton conducting fuel cells for the production of electrically energy or hydrogen (H₂). Specifically, the fuel cells include substantially non-porous, hydrogen (e.g., proton) conducting electrodes that permit the passage of hydrogen while blocking the passage of other gases, such as steam.

### BACKGROUND OF THE INVENTION

Fuel cells can covert the chemical energy stored in fuels into electrical energy at higher efficiencies than conventional heat engines. A conventional heat engine first converts the chemical energy to heat energy through a combustion process (e.g., reacting natural gas and oxygen to form carbon dioxide and water) and harnesses some of that heat energy for mechanical work (e.g., compressing a piston, turning a turbine blade), which then gets converted into the electrical energy. Even under ideal conditions typically more than half the chemical energy released in a heat engine is lost as waste heat.

Fuel cells realize higher conversion efficiencies by eliminating the combustion step when converting fuel reactants (e.g., the natural gas and oxygen) into products (e.g., the carbon dioxide and water). Almost all of the heat energy that would have been generated by combustion is instead channeled into moving electrons (i.e., generating electric current) from sites in the fuel cell where reactants are being oxidized (e.g., H₂→2 H⁺+8 e⁻) to sites in the fuel cell where other reactants are being reduced (e.g., ½ O₂+2 H⁺+2 e⁻→H₂O). Eliminating the combustion step (as well as the mechanical work step) can increase the conversion efficiencies of fuel cells above the 50% level possible with heat engines.

Fuel cell oxidation and reduction reactions take place in a conventional fuel cell where a fuel component or oxidant (e.g., hydrogen, oxygen) comes in contact with an electrode (i.e., anode or cathode) and the fuel cell electrolyte. Because reactants need to reach the reaction sites (and products leave the reaction sites) quickly and easily, the fuel cell electrodes and electrolyte are designed for easy passage of reactants or products.

Conventional fuel cells are designed with porous electrodes to insure fuel cell reactants and other materials can easily access the electrode/electrolyte interface. For example, FIG. 1 shows a hydrogen gas side electrode/electrolyte interface for a conventional proton exchange membrane fuel cell (PEMFC). The interface includes the bulk electrolyte 102 in contact with a porous electrode made up of carbon supports 104 that are coated with catalyst particles 106. Fibers 108 are added to the electrode side to increase the porosity of the electrode. Hydrogen passes freely through the porous electrode structure to undergo oxidation reactions at catalyst particles 106 where there is contact between particles 106, electrolyte 102 and the hydrogen (i.e., “three-phase contact”). The electrode is also permeable to water vapor, which enhances the three-phase contact as well as the diffusion of protons across electrolyte 102 after hydrogen oxidation.

The greater the three-phase contact region between the fuel gas, electrode and electrolyte, the more current that can be generated at the electrode/electrolyte interface (often measured in mA/cm²). Unfortunately, as direct contact between the electrode and electrolyte increases, the more difficult it is for the reactant gases to migrate to the electrode/electrolyte interface, restricting the generation of electric current. Thus, there is a need for fuel cells where the contact between the electrode and electrolyte can be increased without decreasing the migration of reactants (e.g., fuel gas) to the electrode/electrolyte interface.

The porosity of the electrode in FIG. 1 also makes it permeable to liquid water or steam. In the case of a PEMFC this water permeability is important for both increasing the reactions at the electrode/electrolyte interface, as well as the migration of protons across the PEM electrolyte. However, liquid water or steam permeability can often be a drawback, especially when it is desired to operate the fuel cell in reverse by supplying electric power to the fuel cell in order to generate pure hydrogen by, for example, separation from a mixed gas or the electrolysis of steam.

Steam electrolysis occurs when electrical energy converts water molecules (H₂O) into molecular hydrogen (H₂) and oxygen (½ O₂). The electrolysis of water may occur at the cathode of a hydrogen fuel cell working in reverse operation to produce molecular oxygen and protons that migrate across the electrolyte. When the migrating protons reach the anode/electrolyte interface, they may be reduced to from molecular hydrogen. Unfortunately, in the permeable electrode designs of conventional PEMFCs water migrates across the electrolytes with the protons and contaminates the hydrogen being produced at the anode. Thus, there is a need for molecular hydrogen production systems that prevent water from contaminating the hydrogen.

### BRIEF SUMMARY OF THE INVENTION

Embodiments of the invention include a proton conducting fuel cell that includes an electrolyte comprising a proton conducting ceramic. The fuel cell also includes a two-phase diffusion membrane electrode contacting the electrolyte, where the electrode is substantially non-porous and permeable to hydrogen.

Embodiments of the invention also include a method of generating molecular oxygen and hydrogen from a proton conducting fuel cell having a positive and negative electrode in contact with a proton conducting ceramic electrolyte. The method includes the steps of electrolyzing water vapor at a positive electrode of the fuel cell to form molecular oxygen (O₂) and hydrogen ions, and reducing the hydrogen ions at a negative electrode of the fuel cell to form molecular hydrogen (H₂). The electrodes are substantially non-porous and substantially impermeable to the water vapor.

Embodiments of the invention also include a method of purifying hydrogen in a proton conducting apparatus comprising a positive and negative electrode in contact with a proton conducting ceramic electrolyte. The method includes oxidizing molecular hydrogen from an impure hydrogen gas containing impurities at a positive electrode of the apparatus to form hydrogen ions, and reducing the hydrogen ions at a negative electrode of the apparatus to form substantially pure molecular hydrogen (H₂). The electrodes used with the method may be substantially non-porous and substantially impermeable to the impurities.

Additional features are set forth in part in the description that follows, and in part will become apparent to those skilled in the art upon examination of the following specification or may be learned by the practice of the invention. The features and advantages of the invention may be realized and attained by means of the instrumentalities, combinations, and methods particularly pointed out in the appended claims.

### BRIEF DESCRIPTION OF THE DRAWINGS

FIG. 1 shows a conventional PEMFC electrode/electrolyte interface;

FIG. 2 shows an electrode/electrolyte interface according to embodiments of the invention;

FIG. 3 shows a simplified fuel cell for supplying electrical energy to a load, according to embodiments of the invention; and

FIG. 4 shows a simplified hydrogen gas generator according to embodiments of the invention.

### DETAILED DESCRIPTION OF THE INVENTION

The present invention includes fuel cells that include a proton conducting ceramic electrolyte in contact with at least one substantially non-porous electrode that is nonetheless permeable to the diffusion of hydrogen. The hydrogen diffusing through the electrode may be thought of as existing in the same phase as the electrode material and therefore the point where migrating hydrogen reacts at the electrode/electrolyte interface may be referred to as “two-phase” contact, and the electrode may be referred to as a two-phase diffusion membrane electrode.

Since the two-phase diffusion membrane electrode is substantially non-porous, contact between the electrode and the electrolyte is higher than for porous electrodes, thus increasing the electric current that can be generated by the fuel. A high electric current per cm² in the fuel cell is possible because the hydrogen is able to reach the electrode/electrolyte interface without the need for gas phase channels and pores in the electrode.

The substantially non-porous, two-phase electrodes also conduct electrons with less resistance than porous electrodes. The lower electrical resistance of the electrodes reduces a significant cause of parasitic energy loss in the fuel cell due to the electrical energy being converted into waste heat as the electric current gets driven through the electrode. For example, the bulk resistivity of nickel metal is about 1×10⁻⁵ Ω·cm, while the resisitivity of a typical porous nickel cermet (e.g., a cermet with 30% Ni and having 30% porosity) is about 2×10⁻³ Ω·cm.

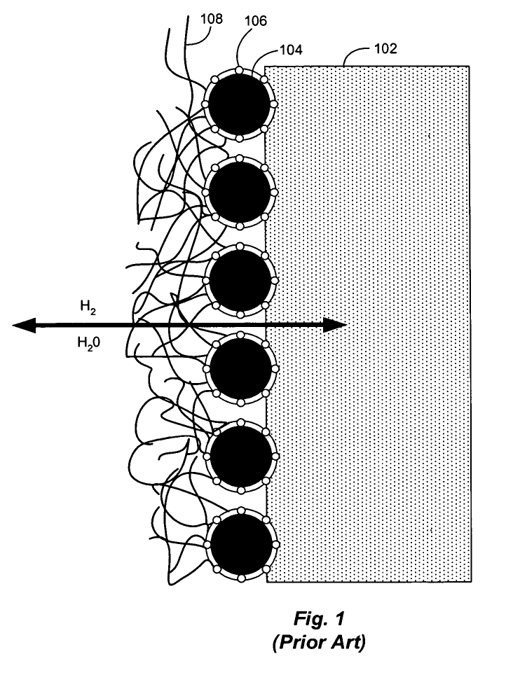

Substantially non-porous electrodes may also act as a protective barrier to prevent corrosive and catalyst inhibiting gas species in fuel and exhaust plenums from attacking the electrolyte material. For example, the porous electrode/electrolyte interface shown in FIG. 1 allows catalyst inhibiting gas species like carbon monoxide (CO) and sulfur dioxide (SO₂) to reach catalyst sites and block hydrogen oxidation at the PEM electrode/electrolyte interface. In addition, the non-porous electrode presents a smaller surface area than porous electrodes to corrosive gases, such as oxides, that can attack the electrode itself.

Substantially non-porous electrodes according to embodiments of the invention may include electrode materials that block the transport of all gas species except hydrogen. Pure hydrogen may be separated from a gas mixture that includes, for example, carbon monoxide, carbon dioxide, water vapor, and other species, including species commonly generated by the reforming of hydrocarbons. Substantially pure hydrogen (H₂) may be selectively removed from the gas mixture by applying a pressure gradient or electrolytically, by applying a voltage across the cell.

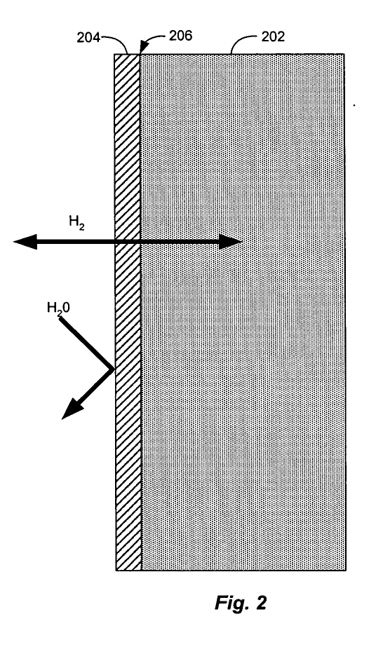

Referring now to FIG. 2, an electrode/electrolyte interface 206 in a fuel cell according to embodiments of the invention is shown. The electrode/electrolyte interface 206 is formed by the contact of the electrolyte 202 with the substantially non-porous, two-phase electrode 204. Electrode 204 may be made from a substantially non-porous material permeable to the migration of hydrogen.

Examples of non-porous materials that may be used in electrode 204 include platinum, palladium, and nickel among other metals. The electrode may be made from a substantially pure metal, and may also be made from alloys of different kinds of metals (e.g., nickel-chromium alloys). Many transition group metals have high hydrogen diffusivities as well as low electronic resistivities, and are therefore suitable for hydrogen diffusion electrodes. Electrodes according to embodiments of the present invention may have hydrogen diffusivities of about 10⁻⁵ cm²/s or more (e.g., about 10⁻³ cm²/s or more). In addition, the electrodes may have electronic resistivities of about 10⁻⁵ Ω·cm or less. The electrode 204 preferably has a thickness of about 5 μm to about 1 μm, or less (e.g., about 3 μm or less).

The non-porous electrode 204 may be substantially impermeable to gases other than hydrogen, such as water vapor, carbon monoxide, carbon dioxide, sulfur containing gases, etc. As noted above, the impermeability of electrode 204 to these gases prevents them from contaminating the bulk electrolyte 202, sites on the opposite electrode (not shown), and fluid (e.g., gas) channels in contact with the opposite electrode.

The electrolyte 202 may be made from a ceramic material (e.g., a solid oxide) capable of conducting protons (i.e., H⁺ ions) while acting as an insulator for electrons to prevent a short circuit between the anode and cathode electrodes. The electrolyte 202 may have an ionic transference number (i.e., the ratio of H⁺ conductivity/total conductivity) of about 0.8 to about 0.9 or more (e.g., about 0.99 or more). Electrolyte 202 may also be formed with a thickness of about 1 mm or less (e.g., about 0.2 mm or less, about 0.05 mm or less, etc.).

In embodiments of the fuel cell of the present invention, electrolyte 202 may be made from a perovskite ceramic having the formula BaCe₍₁₋ₙ₎XₙO_{(3-δ)}, where X, a doppant, may be selected from transition metals, lanthanides, and actinides, n is about 0.05 to about 0.20, and δ (representing the mole fraction of vacant oxygen sites in the ceramic) is about 0.10 or less. For example, the doppant X may be yttrium, gadolinium, or a +3 metal cation and the formula for the perovskite ceramic may be BaCe_{0.9}X_{0.1}O_{(3-δ)}.

Exemplary Fuel Cell

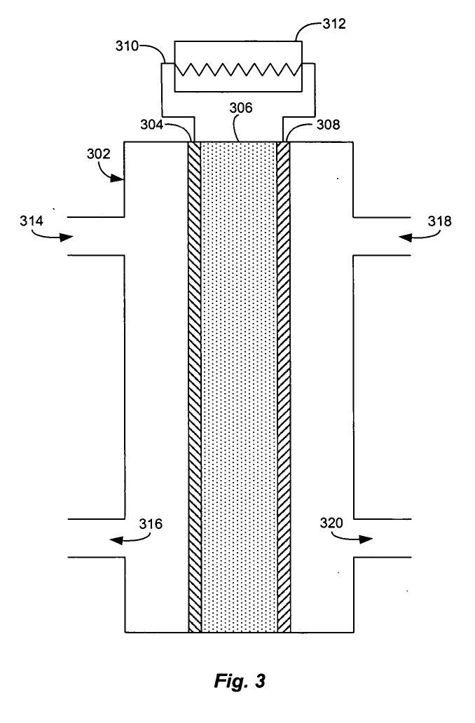

FIG. 3 shows a simplified schematic of a fuel cell 302 according to an embodiment of the invention. The fuel cell 302 includes a proton conducting electrolyte 306 between anode electrode 304 and cathode electrode 308. Electric current travels from the anode electrode 304 to cathode electrode 308 through conductor 310, which may be coupled to a load 312 that harnesses electrical energy from the current to do useful work (e.g., power an electric motor, charge a battery, turn on a light, operate a computer, etc.).

Electrical energy is generated in fuel cell 302 by supplying fuel gases through a fuel gas inlet 314 to the fuel channel side (i.e., the anode electrode side) of fuel cell 302. The fuel used may include hydrogen (H₂), hydrocarbons such methane (CH₄), ethane (C₂H₆), propane (C₃H₈), butane, etc., and combinations of these fuels, among other kinds of hydrogen containing fuels. The hydrogen in the fuel gas may be oxidized at the anode electrode to produce protons that migrate across electrolyte 306 and electrons that supply electric current through anode electrode 304 to cathode electrode 308. Carrier gases (if present), water vapor and other reaction products from the oxidation reaction (e.g., N₂, H₂O, CO₂) may leave the fuel chamber side of fuel cell 302 through fuel side gas outlet 316.

After the electrons deliver electrical energy to load 312, they may participate in the reduction reaction of molecular oxygen (O₂) supplied by oxide gas (e.g., air) passing through oxide gas inlet 318 and protons migrating across the electrolyte 306 to form water. The water vapor, along with other reduction products and (if present) gases that accompanied the oxygen (e.g., N₂) may exit the oxide chamber side of fuel cell 302 through oxide side gas outlet 320.

Fuel cell 302 may operate at a temperature of about 600° C. to about 800° C. (e.g., about 700° C.). The current generated by fuel cell 302 may be about 100 mA/cm² to about 500 mA/cm² or more. Hydrogen fuel gives fuel cell 302 an operating voltage of about 700 mV, and a peak operating power of about 100 mW/cm² to about 250 mW/cm² or more.

As noted above, fuel cell 302 may be used with hydrocarbon fuels such as methane (CH₄). For conventional fuel cells, the methane may undergo a reformation reaction to generate hydrogen (H₂), which is then used in the anode reaction. The reformation is usually done with steam and may be represented by:
CH₄+H₂O→3 H₂+CO (reformation)
The CO produced by the reformation reaction is often converted to carbon dioxide and additional hydrogen in a second reaction called a water gas shift reaction, which may be represented by:
CO+H₂O→H₂+CO₂ (shift reaction)

Unlike PEM fuel cells that must operate at lower temperatures (e.g., less than 100° C.) in order to maintain precise moisture levels in the electrolyte polymers, the fuel cells of the present invention may operate at higher temperatures without the presence of water in the electrolyte. The fuel cells of the present invention operate at temperatures of about 600° C. to about 800° C.

Exemplary Hydrogen Generation System

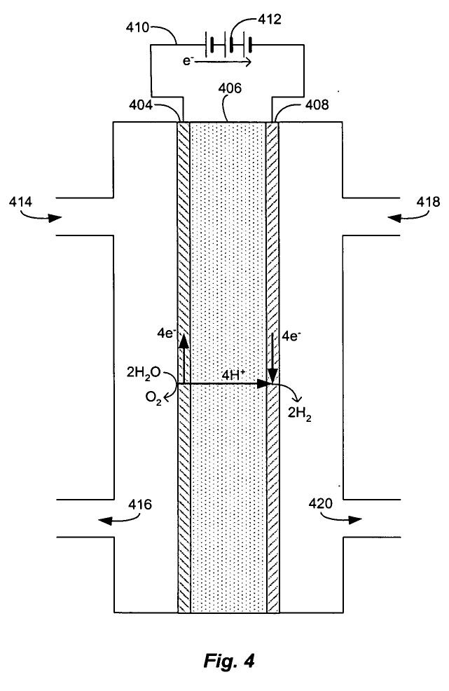

FIG. 4 shows a hydrogen (H₂) generation system according to embodiments of the present invention. In this embodiment, the system may include a fuel cell operating as an electrolyser by replacing load 312 in FIG. 3, with the electrical energy source 412 in FIG. 4 that drives current from the positive electrode 404 to the negative electrode 408. The energy source 412 may be any of a variety of electrical energy sources such as, for example, a power supply coupled to the electric power grid, a photovoltaic (e.g. solar) power system, a wind-electrical power system, a hydroelectric power system, a fuel burning (e.g., coal, natural gas, oil, petroleum, alcohol, etc.) electric power generator, and combinations of these sources.

Source 412 induces the electrolysis of water molecules entering the cell at inlet 414. The water may be oxidized at positive electrode 404, into molecular oxygen (O₂) and hydrogen ions while the electrons are pumped by source 412 from positive electrode 404 to negative electrode 408. The non-porous, hydrogen diffusion electrode 404 permits the protons to migrate across electrolyte 406 while blocking oxygen, H₂O, and other species (e.g., CO, CO₂), which may be carried away with other gases through gas outlet 416. Because electrolyte 406 may be made from protonic ceramic materials that (unlike conventional PEM electrolytes) do not have to be saturated with water to conduct protons, blocking water at electrode 404 does not hinder proton conduction across the electrolyte 406.

The protons conducted across electrolyte 406 may be rejoined with the electrons being pumped through conductor 410 by source 412 at negative electrode 408 to form molecular hydrogen. The hydrogen may then diffuse through the electrode 408 and exit the fuel cell at outlet 420. In some embodiments, a dry carrier gas (e.g., N₂) may be introduced at inlet 418 to help carry the hydrogen diffusing from electrode 404 out of the fuel cell. The inability of oxygen and water to diffuse through positive electrode 404 and migrate across electrolyte 406 with the protons prevents these species from contaminating the substantially pure hydrogen gas that exits the fuel cell at outlet 420.

While the system described in FIG. 4 may act as both a hydrogen generator or a fuel cell, this is not required. Embodiments of the invention may also include hydrogen generation systems dedicated to that purpose that do not reversibly convert into fuel cells. For example, the system may be used as a base station electrolyser for generating substantially pure hydrogen gas for mobile fuel cells (e.g., fuel cells used in transport vehicles such as automobiles, boats, etc.). The electrolyser can constantly generate the hydrogen fuel from a non-mobile electrical energy source 412 so that an adequate supply of hydrogen will be available on demand when a driver needs to “fill-up” the vehicle. The electrolyser may also include a controller (not shown) that may be programmed to generate hydrogen from an electrical power grid at off-peak hours, permitting the capture, storage, and eventual use of energy from the grid that would otherwise be wasted.

It should also be appreciated that the non-porous hydrogen diffusion electrode 404 may also allow the hydrogen generation system of FIG. 4 to act as a hydrogen gas purifier. For example, impure hydrogen gas that includes, for example water vapor, carbon monoxide, carbon dioxide, etc., may enter the cell through inlet 414 and the hydrogen may be oxidized at positive electrode 404, while the impurities (e.g., H₂O, CO, CO₂, etc.) are blocked. The hydrogen ions generated may then be conducted across electrolyte 406 and reduced at negative electrode 408 to make substantially pure hydrogen gas that exits the purification cell at outlet 420.

### EXAMPLES

### Example 1

A hydrogen/air fuel cell according an embodiment of the invention was operated for 750 hours at 750° C. The fuel cell included a 1 mm thick electrolyte disc made from a solid oxide perovskite cermamic called BCY10, which has the formula BaCeo_{0.9}Y_{0.1}O_{(3-δ)}, where δ is about 0 to 0.10. The electrolyte was covered on the cathode side by a platinum electrode and on the anode side by a non-porous 3 μm thick sputtered nickel electrode. The fuel cell produced an average output between 30 and 40 mA/cm² at 700 mV.

### Example 2

Electrical power output of a second hydrogen/air fuel cell according to an embodiment of the invention was measured. This cell included a 500 μm thick BCY10 electrolyte covered on the cathode side by a platinum electrode and on the anode side by a non-porous 2.3 μm thick nickel electrode. The fuel cell produced an average of 100 mA/cm² at 700 mV, with a maximum power of 85 mW/cm².

In both experiments, the fuel gas used was 99.999% dry hydrogen. No contamination or corrosion of the nickel fuel side anode electrode was observed after approximately 3 weeks continuous operation. On the cathode side of the cell, oxygen supplied by air was reduced with the migrating protons to form water. No poisoning or corrosion of the porous platinum electrode or electrolyte was observed.

Having described several embodiments, it will be recognized by those of skill in the art that various modifications, alternative constructions, and equivalents may be used without departing from the spirit of the invention. Additionally, a number of well known processes and elements have not been described in order to avoid unnecessarily obscuring the present invention. Accordingly, the above description should not be taken as limiting the scope of the invention.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included in the invention.

As used herein and in the appended claims, the singular forms “a”, “and”, and “the” include plural referents unless the context clearly dictates otherwise. Thus, for example, reference to “a process” includes a plurality of such processes and reference to “the electrode” includes reference to one or more electrodes and equivalents thereof known to those skilled in the art, and so forth.

Also, the words “comprise,” “comprising,” “include,” “including,” and “includes” when used in this specification and in the following claims are intended to specify the presence of stated features, integers, components, or steps, but they do not preclude the presence or addition of one or more other features, integers, components, steps, or groups.

1. A proton conducting fuel cell comprising:
an electrolyte comprising a proton conducting ceramic; and
a two-phase diffusion membrane electrode contacting the electrolyte, wherein the electrode is substantially non-porous and permeable to hydrogen.

2. The fuel cell of claim 1, wherein the proton conducting ceramic is a solid oxide comprising barium and cerium.

3. The fuel cell of claim 1, wherein the proton conducting ceramic comprises BaCe₍₁₋ₙ₎XₙO_{(3-δ)}, where:
X is selected from the group consisting of a transition metal, a lanthanide, and an actinide with a +3 valence state;
n is about 0.05 to about 0.20; and
δ is about 0.10 or less.

4. The fuel cell of claim 1, wherein the proton conducting ceramic comprises yttrium doped barium cerate or gadolinium doped barium cerate.

5. The fuel cell of claim 1, wherein the proton conducting ceramic comprises BaCe_{0.9}Y_{0.1}O_{(3-δ)}, where δ is about 0.10 or less.

6. The fuel cell of claim 1, wherein the fuel cell operates at a temperature of about 600° C. to about 800° C.

7. The fuel cell of claim 6, wherein the fuel cell operates at a temperature of about 700° C.

8. The fuel cell of claim 1, wherein the electrode is an anode.

9. The fuel cell of claim 1, wherein the electrode is a cathode.

10. The fuel cell of claim 1, wherein the electrode has a thickness of about 5 μm or less.

11. The fuel cell of claim 1, wherein the electrode comprises platinum, palladium, silver or nickel.

12. The fuel cell of claim 1, wherein the electrode comprises sputtered nickel.

13. The fuel cell of claim 1, wherein the electrode is substantially impermeable to water.

14. The fuel cell of claim 1, wherein the fuel cell has a peak power output of about 85 mW/cm² or more.

15. The fuel cell of claim 1, wherein the hydrogen is supplied by methane.

16. A method of generating hydrogen from a proton conducting fuel cell comprising a positive and negative electrode in contact with a proton conducting ceramic electrolyte, the method comprising:
electrolyzing water vapor at a positive electrode of the fuel cell to form molecular oxygen (O₂) and hydrogen ions; and
reducing the hydrogen ions at a negative electrode of the fuel cell to form molecular hydrogen (H₂),
wherein the electrodes are substantially non-porous and substantially impermeable to the water vapor.

17. The method of claim 16, wherein the molecular hydrogen generated by the fuel cell is substantially free of water vapor.

18. The method of claim 16, wherein the water vapor is supplied by air.

19. The method of claim 16, wherein the wherein the proton conducting ceramic electrolyte comprises BaCe_{0.9}Y_{0.1}O_{(3-δ)}, where δ is about 0.10 or less.

20. The method of claim 16, wherein the hydrogen is produced by reforming or partial oxidation of a hydrocarbon.

21. The method of claim 16, wherein the hydrocarbon is methane, ethane, propane, butane methanol, ethanol, or propanol.

22. A method of purifying hydrogen in a proton conducting apparatus comprising a positive and negative electrode in contact with a proton conducting ceramic electrolyte, the method comprising:
oxidizing molecular hydrogen from an impure hydrogen gas comprising impurities at a positive electrode of the apparatus to form hydrogen ions; and
reducing the hydrogen ions at a negative electrode of the apparatus to form substantially pure molecular hydrogen (H₂),
wherein the electrodes are substantially non-porous and substantially impermeable to the impurities.

23. The method of claim 22, wherein the impurities are selected from the group consisting of O₂, H₂O, CO, and CO₂.
